(19) United States
(12) Patent Application Publication
(10) Pub. No.: US 2018/0343672 A1
(43) Pub. Date: Nov. 29, 2018

(54) WIRELESS INFRASTRUCTURE SERVICE

(71) Applicant: Microsoft Technology Licensing, LLC, Redmond, WA (US)

(72) Inventors: Amer Hassan, Kirkland, WA (US); Bill Verthein, Sammamish, WA (US); Mitesh Desai, Sammamish, WA (US); Mark Clear, Snohomish, WA (US); Peter Fortman, Woodinville, WA (US)

(73) Assignee: Microsoft Technology Licensing, LLC, Redmond, WA (US)

(21) Appl. No.: 15/605,794

(22) Filed: May 25, 2017

(51) Int. Cl. H04W 74/02; H04W 48/08; H04B 1/38

(52) U.S. Cl. CPC H04W 74/02; H04W 88/12; H04B 1/38; H04W 48/08

(57) ABSTRACT

Systems, apparatus, and methods according to the embodiments allow a wireless network be efficiently managed through activation and/or deactivation of network access points and/or multi-function devices having capability to serve as access points in the wireless network. An apparatus/server may be configured to manage the access points and multi-function devices based on a network database that is updated as multi-function devices are activated and/or deactivated as access point service providers, and as service conditions change within the network. The multi-function devices may comprise devices that are normally used in the network to provide at least one device function other than access point services. For example, the multi-function devices may include devices, such as printers, display monitors, docking devices, laptops, mobile tablets, or mobile phones, which are intended to provide conventional device functions (i.e., printing, displaying, docking, communicating).

### BACKGROUND

Wireless local area networks (WLANs) that allow devices to connect to a computer network and/or the interact via wireless channels have become ubiquitous. For example, it is more common than not that a corporation, school, government agency, or other type of organization will have a computer network that uses WLAN technology based on one or more of the various IEEE 802.11 Wi-Fi standards. An organization's WLAN typically comprises infrastructure that includes one or more wireless access points (AP) through which computing devices, such as laptop computers, tablets, or mobile phones, may access, and communicate with, the organization's computer network and/or the internet.

An organization's WLAN may be required to support wireless connections for a large number of devices that may move over the wireless coverage area of the APs in the WLAN. The actual area and the traffic volume that needs to be covered by each of the APs may be constantly changing as devices and personnel move and/or are relocated about the organization's buildings or campus. The movement/relocation of devices and personnel within the area of the WLAN may cause temporary or permanent problems with network efficiency as the data traffic load carried by an AP may become too great for the AP to handle, or the signal strength of received signals at an AP may become weak causing errors in the received signals. Also, the movement/relocation of devices and personnel within the area of the WLAN may cause a particular AP to become underutilized as traffic load is shifted among the APs of the WLAN.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

The embodiments of the disclosure include systems, methods, and apparatus that allow efficient management of wireless networks that include one or more access points through use of a wireless infrastructure service. Implementations of the systems, methods, and apparatus allow a wireless network operator to dynamically and flexibly manage traffic carried by access points of the network by utilizing network access points and/or multi-function devices that may be activated to function as access points in the network as appropriate. For example, devices, such as printers, display monitors, docking devices, laptops, mobile tablets, or mobile phones, which are intended to provide conventional device functions (i.e., printing, displaying, docking, communicating) may be configured as multi-function devices that also provide access point services to connect other devices to the network. The multi-function devices may be dynamically managed to provide auxiliary/temporary access point services to other nearby wireless devices operating in the network as the multi-function devices are moved into and out of the coverage area of the network. The support given by the multi-function devices for access point service may be provided based on the needs of the network as network conditions change.

In an implementation, an apparatus may provide dynamic management of access point service in a network that includes conventional access points/base stations and one or more multi-function devices. Each of the multi-function devices may provide a device function, and also may be capable of providing access point services through an access point function. The apparatus may be implemented, for example, as a server within the network or in the cloud. The one or more multi-function devices may be implemented as stationary devices, for example as printers, or desktop PCs. The one or more devices may also be implemented as mobile devices, for example as laptops, mobile tablets, or mobile phones. In operation, the apparatus may determine that an activity associated with a multi-function device, such as power-up, or entry of the device into the network's coverage area, has occurred in the network. For example, the apparatus may determine that a printer having capabilities to provide both a device function (printing function) and access point service has been installed and powered up within the network coverage area to activate the printer function. For example, the printer may be configured so that power up of the printer function causes the printer device to send a message to the apparatus that is has been powered up. Upon determining that the activity associated with the printer has occurred in the network, the apparatus may determine if the printer is able to provide access point services that are needed for the network. If the printer is able to provide access point services, the apparatus may initiate the provision of access point service for the network through the printer while the printer is also used for printing functions. In another example, the apparatus may determine that a mobile tablet or laptop operable to provide both a computing device function and an access service function has been moved into the coverage area of the network. In this case, the mobile tablet or laptop may attempt (automatically or manually) to connect to the network in order that a user of the mobile tablet or laptop may utilize a device function such as Internet browsing, email or other communication functions. Upon determining that the activity associated with the mobile tablet or laptop has occurred in the network, the apparatus may determine if the mobile tablet or laptop is able to provide access point services that are needed for the network. If the mobile tablet or laptop is able to provide the access point service, the apparatus may initiate the provision of access point service for the network through the mobile tablet or laptop while the mobile tablet or laptop is also used for computing functions.

In the example implementation, to determine if the multi-function device associated with the activity is able to provide access point service, the apparatus may query the multi-function device for a device schema that includes information on device capabilities related to any access point functions the device provides. In another implementation, the apparatus may push a service profile of needed access point capabilities to the multi-function device and receive a response as to which capabilities the device may provide. If the multi-function device is able to provide needed access point service, the apparatus may add the device to a network database of available access points. The apparatus may then communicate with the multi-function device to activate and manage access point service for the network in order that the device may be used as an access point. The apparatus may utilize access point change triggers and/or system triggers to determine when to activate/deactivate the access point service provided by the multi-function device.

The apparatus may maintain and update a network database in the form of a heat map that comprises data necessary and/or useful in managing access points and multi-function devices providing access point service in the network. The heat map may include a schema/service profile for each access point of the network implemented as a conventional access point of the network. The heat map may also include a schema/service profile that includes information on the access point service capabilities of each of the one or more to devices, including multi-functional devices such as printers, display monitors, docking devices, laptops, mobile tablets, or mobile phones that have been dynamically added to the network. The heat map may be updated as the one or more multi-function devices are added, or removed from, the network by the apparatus. The heat map may be used in network traffic routing and access point activation and/or deactivation decisions. In other implementations, the network database may be in any other appropriate form that allows data stored in the database to be used in the management of the access points and multi-function devices providing access point service in the network

### BRIEF DESCRIPTION OF THE DRAWINGS

FIG. 1A illustrates an example network including a device operable to provide both a device function and an access point function;

FIG. 1B is a diagram illustrating the network of FIG. 1A subsequent to the activation/entry of another device operable to provide both a device function and an access point function;

FIG. 1C is a diagram illustrating the network of FIG. 1B subsequent to the removal of a device operable to provide both a device function and an access point function;

FIG. 1D is a diagram illustrating an alternative scenario in the network of FIG. 1B subsequent to the removal of a device operable to provide both a device function and an access point function;

FIG. 2A is a simplified block diagram showing an example device configured to provide both a device function and a dynamic access point function;

FIG. 2B is a simplified block diagram showing an example apparatus configured to provide management of access point service in a network;

FIG. 3 is a flow diagram of example operations performed in a network including a device operable to provide both a device function and a dynamic access point function;

FIG. 4A is a flow diagram of operations performed by an example apparatus managing access point functions for a network;

FIG. 4B is a flow diagram of example operations performed by a device operable to provide both a device function and an access point function;

FIG. 4C is a flow diagram of example operations performed by another device operable to provide both a device function and an access point functions;

FIG. 5A is a flow diagram of operations performed by another example apparatus managing access point functions for a network;

FIG. 5B is a flow diagram of example operations performed by a further device operable to provide both a device function and an access point function; and,

FIG. 5C is a flow diagram of example operations performed by a still further device operable to provide both a device function and an access point function;

FIG. 6 is a flow diagram of further operations performed by an example apparatus managing access point service for a network;

FIG. 7 is a simplified block diagram of an example device operable to provide both a device function and an access point function; and,

FIG. 8 is a simplified block diagram of an example apparatus operable to manage access point functions for a network.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The embodiments of the disclosure provide systems, apparatus, and methods that allow a wireless network to be efficiently managed through dynamic activation and/or deactivation of network access points and/or multi-function devices having capability to provide access point service in the wireless network. The multi-function devices may comprise devices that are normally used in the network to provide at least one device function other than access point service. For example, the multi-function devices may include printers, display monitors, docking devices, laptops, mobile tablets, or mobile phones, which are intended to provide conventional device functions (e.g., printing, displaying, docking, or communicating). In the embodiments of the disclosure, these types of devices may be configured as multi-function devices that, in addition to providing a device function, are also capable of providing access point service for the network by serving as an access point to connect other devices to the network.

In an implementation, the infrastructure of a wireless network may be augmented (expanded and retracted) by utilizing a network infrastructure service implemented in a server, to activate/deactivate the access point capabilities of multi-function devices operating within a network's coverage area and manage the operation of the multi-function devices as access points. The multi-function devices may be added to, or removed from, the access point infrastructure of the network to keep an organization's wireless network operating efficiently as the organization increases or decreases in size and user traffic patterns change. In addition, the network infrastructure service may also be utilized to manage the network access points that are part of the permanent network infrastructure. The management of the network access points may be performed either separately or in combination with the management of the multi-function devices.

Use of the embodiments may reduce the burden of needing to design an initial “perfect” network that provides optimal coverage from the start. Instead of fixing an initial access point infrastructure based on guesses or estimations about how devices and a network will be utilized or change over time, modifications to improve network efficiency/performance may be made by augmenting the network as the network is actually used. In some cases this may prevent over spending on infrastructure that will be underutilized. For example, because enterprise Wi-Fi deployments are costly (a single access point may cost between $1500 and $3000, an average wireless controller may cost $20K, and installation may average $1000 per access point) it may not be economical to configure a permanent Wi-Fi network to provide coverage and robustness to the tail 5%-10% of corporate space that produces little or no activity.

The embodiments allow a network operator to take advantage of “stationary devices” and “mobile devices” as organizational assets to augment a wireless network including infrastructure comprising network access points. In implementations described in this disclosure, the term “network access point” or “access point” will be used to refer to an access point that is configured by network managers to operate in a network to provide access point service as its function. This type of network access point or access point may be considered part of the permanent network infrastructure. The location and movement/position of a network access point may be under the control of the network managers The terms “stationary devices” and “mobile devices” will be used to refer to multi-function devices configured to provide a device function other than access point services, in addition to providing access point services, that may be positioned or located in a network's coverage area, or that may move into or within a network's coverage area, as a result of device user activities that are not under network control.

The stationary devices may include “stationary fixed” devices that essentially become fixed devices as far as location within the organization's network infrastructure. These fixed devices may include large sized corporate printers, servers in data centers, built-in conference room projectors, built-in (wall mounted) large size display monitors, etc. The stationary devices may also include “stationary semi-fixed” devices that may be user installed and, operate while stationary, but do not become a fixed part of the corporate/organization network as far as location. These semi-fixed devices may be moved and relocated by users throughout the network's coverage area from time to time. For example, these semi-fixed devices may include televisions, monitors, personal printers, and desktop PCs that may be moved according to user and/or organization needs but generally stay in one location when operating. The mobile devices may include devices that are portable and moved throughout the network's coverage area during normal operation. The mobile devices may include, for example, portable docking devices, computer tablets, laptops, and mobile phones.

In an implementation, a network database comprising a heat map may be constructed that reflects the wireless service capabilities of an organization's network access points and stationary/mobile device assets. The heat map may include information about the access point service capabilities of each access point and each stationary/mobile device operating in the network. The heat map may include a schema associated with each stationary or mobile device in the network that is configured or available to provide access point service. In addition, the heat map may also include a schema associated with each access point of the network. The heat map may be stored in a server that is based in the cloud or that is located within the network infrastructure. The heat map may be updated and/or synchronized on a scheduled basis according to activity in the network. In other implementations, the network database may comprise a database in any appropriate form that allows stored information associated with the capabilities of access points and/or stationary/mobile devices operating in the network to be utilized for access point service management.

In an example implementation, the schema data included in the schema for each multi-function device or access point may include a “name,” “type,” “location,” “location accuracy,” and “type of service.” The device name may uniquely identify the access point or multi-function device. The type may be a designation of “permanent,” “stationary fixed,” “stationary semi-fixed,” or “mobile.” For example, a network access point may be designated as permanent, a device comprising a built-in conference room projector may be designated as stationary fixed, a laptop may be designated as semi-fixed, and a mobile phone may designated as mobile. The location may indicate a location of the device or access point within the network coverage area according to a last known location update. The location accuracy may indicate a location accuracy that reflects the confidence in the last known location of the access point or multi-function device being accurate. The location accuracy may be based at least in part on the type, the propensity/ability of a user to move the device, and the frequency with which the actual location is updated. For example, a permanent network access point may be associated with an accuracy of 100%, a stationary fixed device comprising a built-in conference room projector may be associated with a location accuracy of 100%, a stationary semi-fixed device comprising a laptop may be associated with a location accuracy of 80% and a mobile phone may be associated with a lesser accuracy of 10%. The type of service may indicate one or more of whether the device may provide internee service, the type of connection (fast, slow) the device may provide, whether the device is managed (IT), whether the device is configured to provided guest access, and performance related service aspects such as available device power levels and device media capability.

In an implementation, the network infrastructure service may be dynamically deployed and managed by using a query process. In this implementation, the network infrastructure service may query a multi-function device that is activated in, or moves into, the network coverage area for the device's schema. The network infrastructure service may then amend/reconfigure the access point infrastructure by adding the multi-function device to provide access point service if the multi-function device's schema satisfies network requirements. For example, at the time of activation of a multi-function device, the network may need high speed video support and the network infrastructure service may only add the newly activated multi-function device if the device can support a certain data rate. In an alternative implementation, the network infrastructure service may push a service profile indicating network access point service needs to a multi-function device upon device activation in the network. The multi-function device may then respond to indicate to the network infrastructure service whether or not the multi-function device can support the service profile. If the multi-function device supports the service profile, the network infrastructure service may amend/reconfigure the access point infrastructure.

Also, in various implementations, the use of trigger event detection by the network access service provides an efficient way to manage a network that uses network access points and/or multi-function devices to provide access point service. In this case, the network infrastructure service may be triggered to reconfigure network infrastructure based on the occurrence of trigger events that indicate one or more access point service conditions has changed. For example, if changes occur in traffic volume the network infrastructure service may turn access point services provided by selected multi-function devices on or off in response to the changes in traffic volume. In another example, if traffic volume increases, more multi-function devices may be utilized to provide access point service. If traffic volume decreases, selected multi-function devices may be removed from use in providing access point services. Also, changes in traffic volume and/or changes in the number of multi-function devices utilized to provide access point service may be used as a trigger to adjust transmitted RF power of access points and/or multi-function devices providing access point service. For example, if traffic volume/number of devices using the network decreases, the transmit RIF power levels of access points and/or existing multi-function devices may be increased to provide better service to the remaining devices. If traffic volume/number of devices using the network increases, the transmit RF power levels of the access points and/or the remaining multi-function devices may be decreased to avoid interference with the larger number of devices. In another example, if additional multi-function devices are added to the network within the existing network coverage area, the transmit RF power levels of access points and/or existing multi-function devices may be reduced to account for the presence of the newly added multi-function devices. If multi-function devices are removed from the network, the transmit RF power levels of the access points and/or the remaining multi-function devices may be increased to account for the absence of the removed multi-function devices.

A trigger event may also comprise the breakdown of a permanent access point that needs to be replaced by the access point capability of a multi-function device. In addition, the network infrastructure service may manage access point services based on an event trigger in combination with considering the schemas of the multi-function devices available to provide access point service. For example, the access point service may direct traffic (e.g., route high quality traffic through a first multi-function device rather than through a second multi-function device) based on an event trigger (high quality traffic capability needed) and on capabilities indicated by the schema of the various multi-function devices added to the system.

In various implementations, the multi-function devices that are used to add additional access point service capability may be “trusted” or “untrusted” devices. The trusted devices may be an organization's devices that are configured by a network operator with appropriate application programming interfaces to provide secure network access point services when activated. The untrusted devices may be private devices or an organization's devices that are configured with a generic application that allows the untrusted device to be configured in the network to provide “guest” access point service for connecting to the internet. For example, the generic application may be a standardized application that allows a multi-function device to communicate with a network having a capability compatible with the generic application.

In one example, an organization's device may include an application that forces an untrusted multi-function device that is providing guest access point services to access the organization's virtual private network (VPN) to connect to the organization's device. This may be done when the organization's device connects to the multi-function device for network access. This may be advantageous when all secure access points in a network are congested. For example, in a congestion situation, an organization's devices may be allowed to connect securely to the organization's network through less secure, but less congested, multi-function devices providing access point service using the organization's VPN.

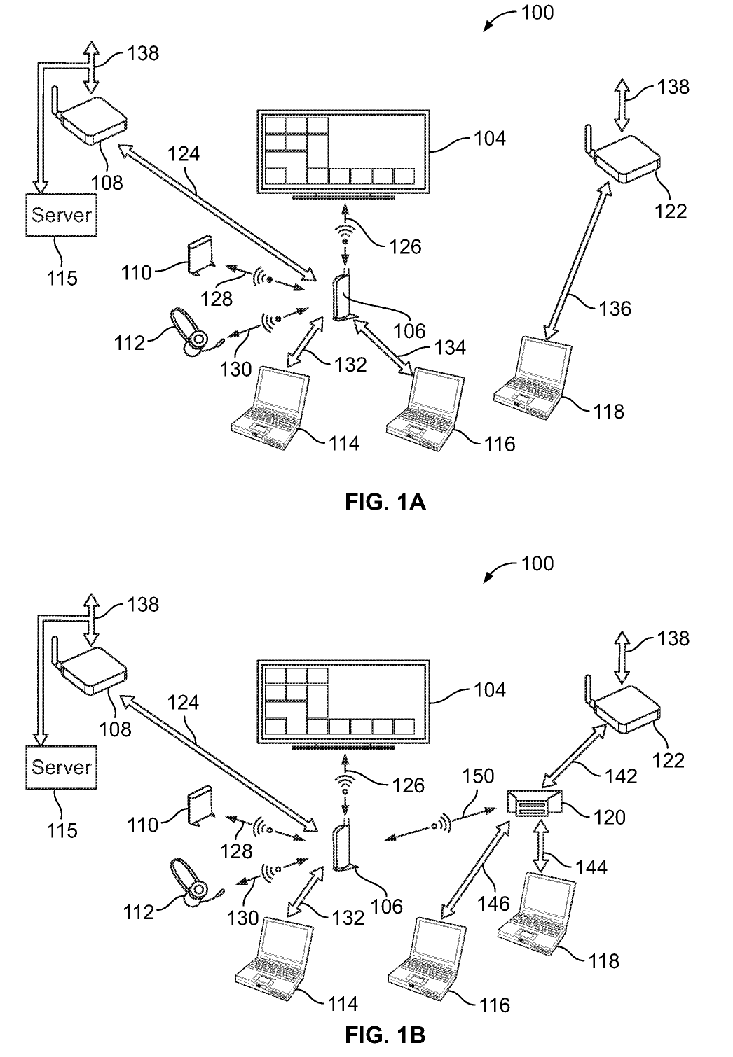

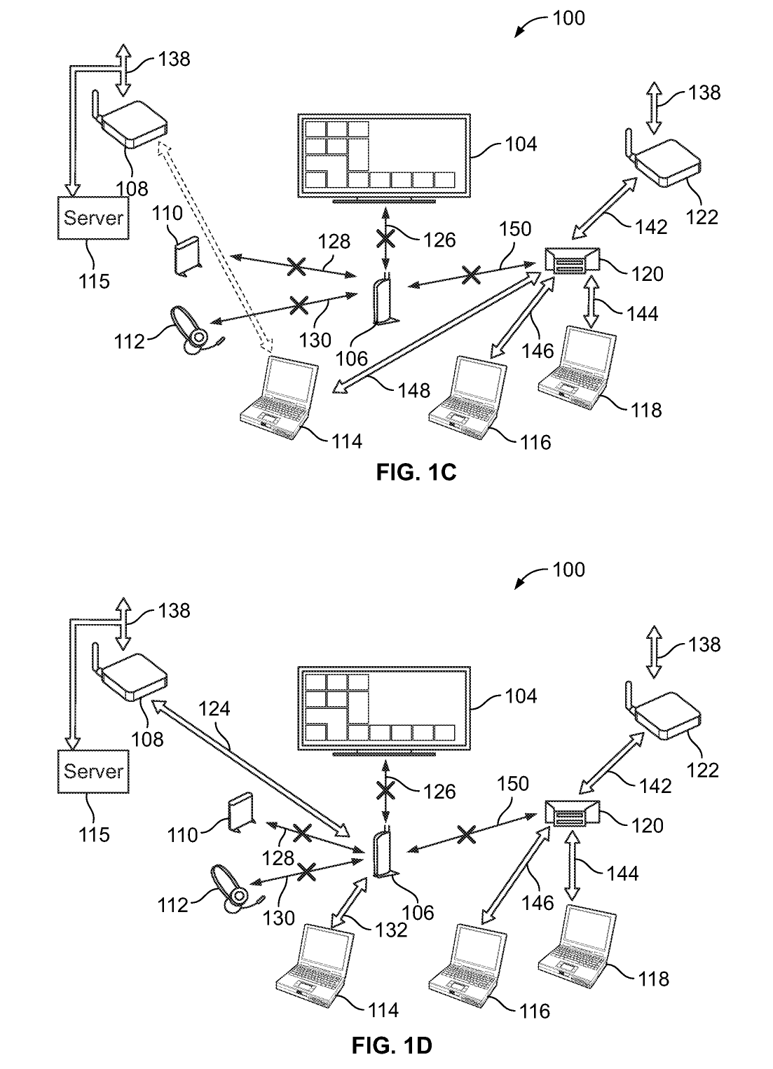

FIGS. 1A-1D illustrate scenarios associated with an example network 100 including a docking device 106 and printer device 120 (shown in FIGS. 1B-1D) operable to provide both a device function and a dynamic access point function for the network. Network 100 includes server 115, network access point (AP) 108, display monitor device 104, network access point (AP) 122, storage device 110, headset device 112, computing device 114, computing device 116, computing device 118, docking device 106, and printer device 120. Network 100 may include any number of other devices and/or access points that are not shown. Docking device 106 may be a multi-function device that provides both docking functions and access point functions to other devices. Printer device 120 may be a multi-function device that provides both printing functions and access point functions to other devices. Network access point (AP) 108 and network access point (AP) 122 are connected to the backend network and server 115.

FIG. 1A shows an example scenario of network operation according to an implementation of the disclosure. In FIG. 1A, docking device 106 is providing functions that allow storage device 110, headset 112, and display monitor 104 to communicate with one another through docking device 106. Docking device 106 may connect with storage device 110 and headset 112 over connections 128 and 130, respectively. Docking device 106 may be further connected with display monitor 104 over connection 126. In addition, docking device 106 is also shown providing the functions of an access point to computing device 114 by connecting computing device 114 to AP 108 (functioning as a connection to the backend/internet network 138) through docking device 106 over connections 132 and 124. Docking device 106 is also shown providing access point service connections to computing device 116 through docking device 106 over connections 134 and 124 to AP 108 (functioning as a connection to the backend/internet network 140). FIG. 1A also shows computing device 118 connecting to AP 122 (functioning as a node to the backend/internet network 138) over connection 136. The connections 124 126, 128, 130, 132, 134, and 136 may be implemented over any appropriate type of wireless channels. For example, connections 136, 132, 134 and 124 may comprise WiGig high speed connections for carrying high speed media traffic, and connections 126, 128, and 130 may comprise slower speed connections such as Bluetooth or Wi-Fi Direct connection.

Docking device 106 may be managed and controlled by server 115 to provide access point services to other devices, such as computing devices 114 and 116, based on the location and/or the operating state (powered on or off) of docking device 106. For example, if the location and/or operating state of docking device 106 changes from that in FIG. 1A, the server 115 may configure a new access point infrastructure for network 100 by configuring docking device 106 to provide access point services based on docking device's 106 new location and/or operating state. Also, the server 115 may dynamically manage and control the access point services provided by docking device 106 as other multi-function devices that provide access point services are added to, or removed from, network 100.

FIG. 1B is a diagram illustrating the network of FIG. 1 in a scenario subsequent to the activation entity of a new device operable to provide both a device function and access point function. FIG. 1B shows a scenario in which server 115 of network 100 has reconfigured the access point service of network 100 subsequent to a new multi-function device (printer device 120) capable of functioning as an access point powering up or entering the network coverage area. FIG. 1B shows network 100 including the devices of FIG. 1A along with the additional printer device 120. Printer device 120 may also be a multi-function device that provides the device function of printing and that also provides the additional function of access point service. FIG. 1B shows network 100 subsequent to printer device 120 being powered up in network 100. The server 115 has reconfigured and managed the access point service of network 100 so that computing device 116 is now connected through connection 146 to the printer device 120, and, through printer device 120 and connection 142 to network access point 122. Computing device 118 is now connected through connection 144 to the printer device 120, and through printer device 120 and connection 142 to network access point 122. In an implementation, the reconfiguration/rerouting of the connection for computing device 116 to network access point 122 may have been performed because printer device 120 allows a better quality connection for computing device 114 to network access point 122 than was provided through docking device 106.

FIG. 1C is a diagram illustrating the network of FIG. 1B in a scenario subsequent to the removal/powering down of a device operable to provide both a device function and dynamic access point functions. FIG. 1C shows the devices of FIG. 1B in a scenario in which server 115 of network 100 has reconfigured the access service of network 100 subsequent to a multi-function device (docking device 186), that was providing an access point function, being removed or powered down. The server 115 has reconfigured and managed the access points of network 100 so that computing device 114 is now connected to network access point 122 through connection 148 to the printer device 120. and through printer device 120 and connection 142 to network access point 122.

FIG. 1D is a diagram illustrating an alternative scenario in the network of FIG. 1B subsequent to the removal/powering down of a device operable to provide both a device function and dynamic access point functions. FIG. 1D shows a scenario in which an alternative implementation of docking device 106 has been utilized to maintain access point service that was added to network 100 with the activation/entry of docking device 106 in the network 100, subsequent to the removal/powering down of docking device 106. In the scenario of FIG. 1D, docking device 106 has been configured by server 115 to continue to provide access point functions even though docking device 106 has been powered down, or deactivated, as far as providing the docking function. For example, docking device 106 may be configured so that once docking device 106 is configured to provide access point service, network 100 may control docking device 106 to keep the access point service provided by docking device 106 powered up and turned on, even when a user powers off docking device 106. For example, APIs may be configured in docking device 106 and in server 115 that allow server 115 to have control over the circuitry that controls power on/off in docking device 106. Server 115 may then override a powering down of docking device to 106 keep the portions of docking device 106 that provide access point service powered on.

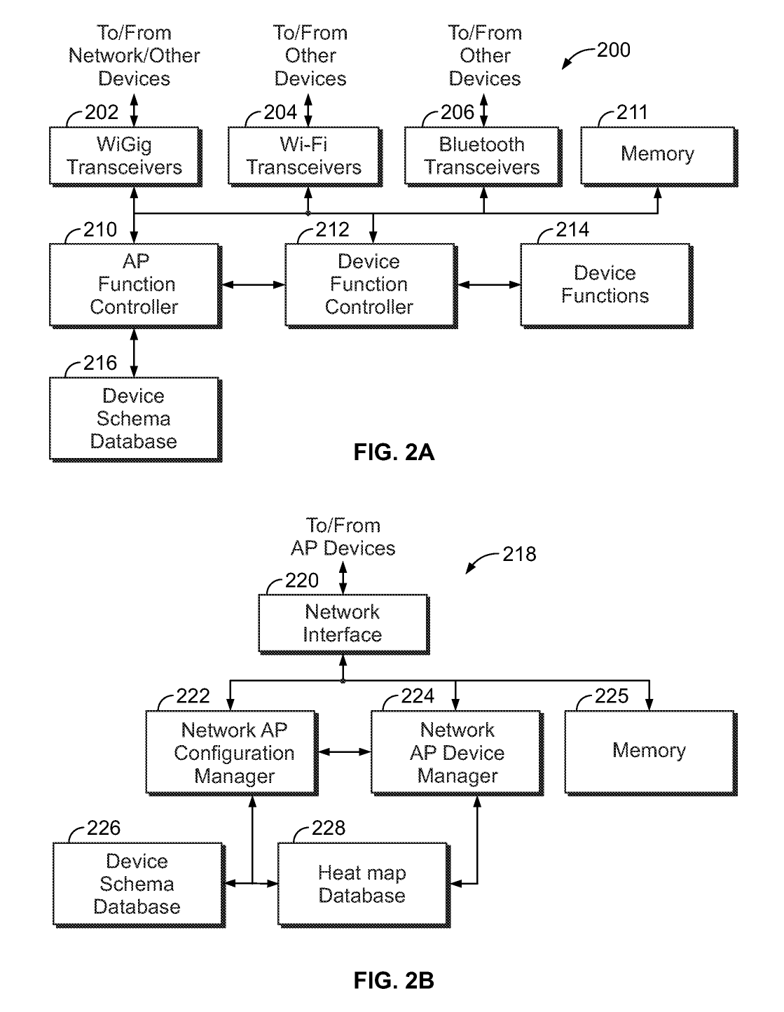

FIG. 2A is a simplified block diagram showing portions of an example device 200 configured to provide both a device function and a dynamic access point function. Device 200 may represent, for example, docking device 106 or printer device 120 of network 100 that are shown in FIGS. 1A-1D. Device 200 includes WiGig transceivers 202, Wi-Fi transceivers 204, Bluetooth transceivers 206, AP function controller 210, memory 211, device function controller 212, device functions 214, and device schema database 216.

In operation, AP function controller 210 may control network access point functions configured in device 200 to cause device 200 to provide access point service to connect other devices to a network. For example, when device 200 is implemented as printer device 120 of FIGS. 1B-1D, AP function controller 210 may control WiGig transceivers 202 to connect computing devices 116 and 118 to network 100 through network access point 122. In this example, AP function controller 210 may make these connections under the control of AP control programs stored in memory 211 and instructions that are received through WiGig transceivers 202 from an access point service implemented in server 115 of network 100.

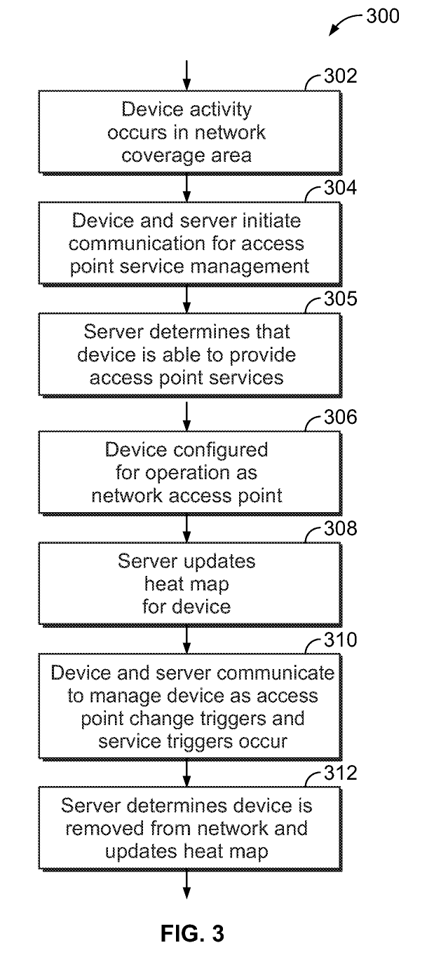

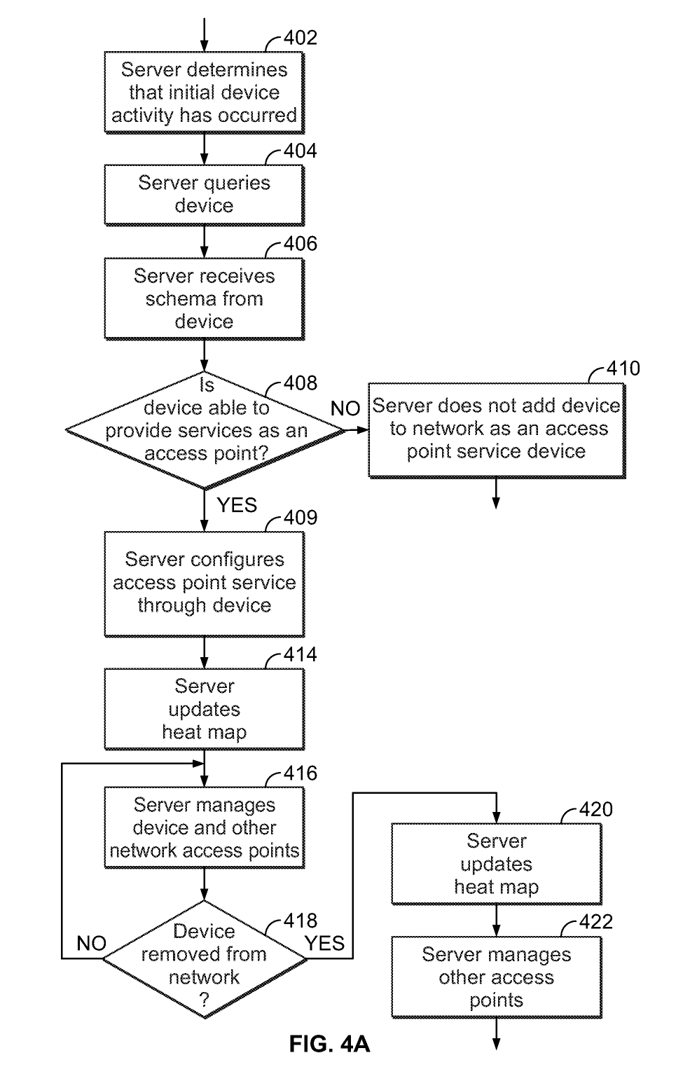

The AP control programs stored in memory 211 may comprise one or more applications that allow AP function controller 210 to communicate with and be managed by an access point service. Also, in operation of device 200, device function controller 212 may control device functions 214 implemented in device 200. For example, using printer device 102 of FIG. 1B as an example, device function controller 212 may control Wi-Fi transceivers 204 and/or Bluetooth transceivers 206 to receive printer jobs from computing device 114 through docking device 106 over connection 150 and provide the function of a printer. Device function controller 212 may do this under the control of programs and/or a device operating system stored in memory on device 200. Docking device 106 of FIGS. 1A-1D may function in a similar manner as described for printer device 120 to provide access point services and device functions. In the case of docking device 106, the device functions would be the docking functions provided to connect the various devices, such as storage device 110, headset device 112, and monitor display device 104 to one another. In other implementations of device 200, device 200 may provide any other type of device function, or device functions, in addition to access point services. The details of particular implementations of device 200 will be explained further in relation to the flow diagrams in FIGS. 3, 4B-4C, and 5B-C.

FIG. 2B is a simplified block diagram showing portions of an example apparatus 218 configured to provide dynamic management of access point service in a network. Apparatus 218 includes network interface 220, network AP configuration manager 222, network AP device manager 224, memory 225, device schema database 226, and heat map database 228.

Network AP configuration manager 222 may communicate through network interface 220 with a device such as device 200 of FIG. 2A to configure AP function controller 210 to provide access point services to other devices in a network. Network AP configuration manager 222 may do this under the control of programs stored in memory 225 that communicate with applications/programs stored on device 200. Network AP configuration manager 222 may send/download AP control programs or instructions to device 200 to configure the access point service functions of device 200. Network AP configuration manager 122 may utilize data from a schema for device 200 stored in device schema database 226, and data from heat map database 228 in creating instructions or determining AP control programs to be sent to AP function controller 210 of device 200. The schema for device 200 may include information on device capabilities related to the access point services that device 200 may provide. In one example, a schema may be received from device 200 in response to query sent by apparatus 218 upon an initial activation of device 200 in a network and then be stored in device schema database 226 for future use. The schema may also be pre-stored in device schema database 226 by a network administrator. Device schema data base 226 may include a schema for each access point and each multi-function device operating in a network. For example, when apparatus 218 is implemented as server 115 of FIGS. 1A-1D, and device 200 of FIG. 2A is implemented as either of docking device 106 and/or printer device 120 of FIGS. 1A-1D, device schema data base 226 may include a schema for each of docking device 106, printer device 120, network access point 108, and network access point 122.

Network AP configuration manager 222 may also configure a heat map stored in heat map database 228 using the data from device schema database 226. The heat map may include information on the capabilities of the access points and multi-function devices that are configured and/or available in the network to provide access point service. The heat map may also include information on access point service conditions in the network that may be updated by Network AP device manager 224 as network operations occur. For example, the heat map may include information on service conditions such as current traffic loads, currently available bandwidths, and other conditions or parameters associated with network access points and multi-function devices operating in the network. In the example of apparatus 218 implemented as server 115 of FIGS. 1A-1D, the heat map may include information on the capabilities, and current conditions, such as traffic loads and available bandwidths, associated with each of each of docking device 106, printer device 120, network access point 108, and network access point 122.

During operation network AP configuration manager 222 may reconfigure the device schema database 226 and heat map database 228 so that those databases remain current with conditions in the network. For example, in an implementation of apparatus 218 as server 115 in the scenario of FIG. 1C in which docking device 106 is powered down and not providing access point service, AP configuration manager 222 would determine that docking device 106 has been powered down, and reconfigure the device schema database 226 and heat map database 228 to reflect the removal of docking device 106 as a device able to provide access point service for network 100.

During operation, as conditions change in the network, network AP device manager 224 may control access points and multi-function devices of a network according to data in device schema database 226 and the heat map in heat map database 228 to provide access point service to particular devices and route wireless traffic in an optimized way. Network AP device manager 224 may also update and supplement the heat map in heat map database 228 used in access point configuration by network AP configuration manager 222 and used in routing by network AP device manager 224. Network AP device manager 224 may add traffic volume routing data to heat map database as network configuration manager 222 and network AP device manager 224 perform their functions over time. For example, in an implementation of apparatus 218 as server 115 in the scenario of FIG. 1C in which docking device 106 is powered down, network AP device manager 224 may determine that docking device 106 has been powered down from the reconfiguration of device schema database 226 and heat map database 228 performed by network AP configuration manager 222. Network AP device manager 224 may then reroute access point service traffic though printer device 120 to provide access point service to computing device 114. The details of particular implementations of device 218 may be explained further in relation to the flow diagrams in FIGS. 3, 4A, 5A and 6A.

FIG. 3 is a flow diagram of example operations performed in a network that includes devices operable to provide both a device function and dynamic access point service. FIG. 3 may be explained with reference to FIGS. 1A-1D using docking device 106 (configured as device 200 of FIG. 2A) as the device of FIG. 3, and server 115 (configured as apparatus 218 of FIG. 2) as the server of FIG. 3.

The process begins at 302 where an initial activity of docking device 106 occurs in the coverage area of network 100. The initial activity of docking device 106 may be the powering up of docking device 106 that activates docking device 106 to perform the docking functions of connecting storage device 110 and headset device 112 to display monitor device 104. Network AP configuration manager 222 of server 115 may receive a registration/alert message from AP function controller 210 of docking device 106 indicating that docking device 106 has been powered up in the coverage area of network 100. Alternatively, the initial activity of docking device 106 may be the movement of docking device 106 into the coverage area of network 100 while powered up. The initial activity by docking device 106 may also comprise an initial access attempt to network 100 at a network access point (access point 108 or 122), or another multi-function device providing access point services, to connect to network 100 and obtain access point services for its docking function. The infrastructure service of network 100 may be configured to detect these or other types of initial activity by docking device 106.

At 304, AP function controller 210 of docking device 106 and network AP configuration manager 222 of server 115 initiate communications for access point service management. These communications may be performed using action frames that carry proprietary information elements. For example, the action frames may be configured as the action frames specified in sub clause 8.5 of the IEEE 802.11 specification. Server 115 and docking device 106 may be configured with application programming interfaces (APIs) that communicate with each other to exchange the information elements included in the action frames. These APIs may be installed on each network access point and on each multi-function device that is capable of providing access point service in the network. For example a wireless network administrator for an organization may install these APIs in network access points and in stationary or mobile devices that are issued to employees of the organization. The network access points and the employees' devices may then be managed by the network's infrastructure service according to the disclosed implementations. In one example, APIs that are installed on the multi-function device may be configured to facilitate the detection of the initial activity of the multi-function device by server 115 in operation 302.

The communications at 304 may include the sending of a device schema by AP function controller 210 of docking device 106 to network AP configuration manager 222 in response to a schema query from server 115. AP function controller 210 may retrieve the device schema from device schema database 216 of docking device 106. AP configuration manager 222 may store the received device schema in device schema database 226 of server 115. Alternatively, the communications at 304 may include the pushing of information about needed/usable access point services by network configuration manager 222 of server 115 to AP function controller 210 of docking device 106. The communications at 304 may take place though WiGig connection 124, with docking device 106 using WiGig transceivers 202 and server 115 using network interfaces 220 to send and/or receive messages.

In the case where docking device 106 sends a device schema to server 115 at 304, the schema for device 106 may include one or more information fields. For example, the schema may include a “device name,” “device type,” “location,” “location accuracy,” and “type of service.” The device name may uniquely identify docking device 106 among other devices in network 100. The device type in the device schema may be a designation of “stationary fixed,” “stationary semi-fixed,” or “mobile.” In the case of docking device 106, the device type may be designated as stationary semi-fixed since a docking device normally is not moved when being used. The location in a device schema may indicate a location of the device within the network coverage area according to a latest location update. The location accuracy may reflect the confidence in the location being accurate. The location accuracy may be based at least in part on the device type and/or on available historical data related to the propensity/ability of a user to move the particular device. In an example, docking device 106 may be assigned a location accuracy of 80% based on the device being stationary semi-fixed. Docking device 106 may be assigned a type of service including one or more parameters that indicate its technical capabilities to provide internet service. Because docking device 106 communicates with, and is managed by, server 115, the type of service may include an indication that docking device 106 is managed by the IT that is responsible for network 100.

At 305, based on the communications with AP function controller 210 of docking device 108, network AP configuration manager 222 of server 115 determines that docking device 106 is able to function as an access point and provide access point services for network 100. For example, in the case in which AP function controller 210 of docking device 106 sends a device schema to network configuration AP manager 222 of server 115, network configuration AP manager 222 may determine from the received schema that docking device 106 is able to provide a certain level of AP service that is needed in network 100. In an alternative case in which information about needed access point services is pushed to docking device 106, network AP configuration manager 222 may receive a response from AP function controller 210 that indicates which of the needed access point services docking device 106 is able to provide and make the determination that docking device 106 is able to provide particular access point services based on the response.

At 306, based on the determination that docking device 106 is able to provide the needed access point services for network 100, network AP configuration manager 222 of server 115 may configure docking device 106 for operation as a network access point. The configuring at 306 may including the sending/downloading of AP control programs to docking device 106 that will be stored in memory 211 and control the AP function controller 210 of docking device 106 in operation as an access point. The configuration at 306 may also include sending a set of operating instructions to docking device 106 that instruct AP function controller 210 of docking device 106 on what operating parameters to use. For example, the operating instructions may include a service set identifier (SSID) for docking device 106 to use when providing access point services. The operating instructions may also include a temporary MAC ID and instruct docking device 106 to change its MAC ID to the temporary MAC ID when providing access point service. The operating instructions may also define parameters such as data rates, channels, security procedures, and verification procedures to be used by docking device 106 when functioning as an access point. Alternatively, the configuring at 306 may include network AP configuration manager 222 sending instructions for AP function controller 210 to implement operating parameters according to AP control programs that may be pre-stored in docking device 106. In an implementation, the AP control programs sent from network AP configuration manager 222 to AP function controller 210 may also allow network AP configuration manager 222 to control docking device 106 to override user control of docking device 106. For example, the AP control programs may allow AP configuration manager 222 to control AP function controller 210 provide access point functions even though a user has powered down docking device 106.

At 308, network AP configuration manager 222 of server 115 may update heat map database 228 to reflect that docking device 106 is now configured as an access point. The updated heat map may reflect the access point coverage now available in network 100 with docking device 106 available for use as an access point. The updated heat map may also include the schema of docking device 106.

At 310, AP function controller 210 of docking device 106, and network AP device manager 224 of server 115 communicate to manage the access point services provided by docking device 106 based on the occurrence of access point change triggers and service change triggers in the network. The access point change triggers and service change triggers that occur in the network may include events that may affect the provision of access point services by docking device 106. These events may require changes or modifications to the operation of docking device 106 by network AP device manager 224. For example, even though docking device 106 is powered up in the coverage area of network 100, docking device 106 may be held at 310 as a reserved access point and not used until an access point change trigger or service change trigger occurs that indicates docking device 106 is needed as an access point. Also, during the time that docking device 106 is providing access point services at 310 (or held as a reserved access point), docking device 106 also may provide its normal device function as a docking device. For example, device function controller 212 of docking device 106 may control device functions 214 and utilize Wi-Fi transceivers 204 and/or Bluetooth transceivers 206 to connect storage device 110, headset device 112, and display monitor 104 (of FIGS. 1A-1D) to allow those devices to communicate with one another. In an example of operation at 310, the state of docking device 106 may be as shown in FIG. 1A, with docking device 106 providing docking connection functions to connect storage device 110, headset device 112, printer device 120, and display monitor 104 with one another, and providing access point functions to connect computing devices 114 and 116 to network access point 108 and network 100.

An access point change trigger at 310 may include a detection of a change in the access point service configuration of network 100. An access point change trigger may include detection of the powering down of an access point, or the powering down of a multi-function device providing both a device function and access point service in network 100, that removes the powered down access point or device from providing access point service. A powering down event generating an access point change trigger may comprise, for example, the powering down of a multi-function device such as docking device 106 or printer device 120, or the powering down of a permanent access point for maintenance that results in cessation of activity by the multi-function device or access point in the network. An access point change trigger may also include the detection of the powering up of a new multi-function device capable of providing both a device function and access point service, or installation of a permanent access point. In the case of an access point change trigger occurrence, network AP configuration manager 222 and network AP device manager 224 will manage docking device 106 as needed to account for the changed access point environment of network 100. For example, this managing may include sending instructions to AP function controller 210 of docking device 106 to take on additional access point traffic in network 100. The instructions may also cause AP function controller 210 of docking device 106 to adjust operating parameters of its access point function to account for the changes. For example, AP function controller 210 may control docking device 106 to begin providing access point service on additional channels upon the occurrence of an access point change trigger caused by removal of an access point, or a multi-function device providing both a device function and access point service, from network 100. In another example which is illustrated by FIGS. 1A and 1B, in the scenario shown in FIG. 1A, access point 108, access point 122, and docking device 106 may be each be assigned a transmission power level and channel set, based on a desired level of coverage within the area that includes computing devices 114, 116, and 118. When the scenario changes to the scenario shown in FIG. 1B, and printing device 120 is powered up and begins to provide access point services, the transmission power level or the size of the channel set used by docking device 106 and/or access point 122 may be reduced to account for the additional access point services provided by printer device 120.

A service trigger may include the detection of an event that affects ongoing access point service in network 100. For example, a service change trigger may include the detection of traffic congestion or the detection of a lowered quality of service on one or more access point service channels. In the case of a service change trigger occurrence and detection, network AP configuration manager 222 and network AP device manager 224 will manage docking device 106 as needed to account for the effects on access point service in network 100 caused by the event generating the service change trigger. For example, this management may include instructing AP function controller 210 of docking device 106 to handover, or receive handover of, data traffic to/from other access points in network 100 that become congested. The management may also include adjusting operating parameters of the access point function of docking device 106. For example data transmission rates or power transmission levels used by docking device 106 may be increased, or a channel set used by docking device 106 may be expanded to account for the occurrence of a lowered quality of service on one or more access point service channels. In another example, a service change trigger may include the detection that there are adequate access point service resources available and that access point service resources provided by docking device 106 may be reduced or removed from network 100. In this case, the power levels used by docking device 106 or the channel set used by docking device 406 may be reduced.

The provision of access point services by docking device 106 according to the operations of 310 may continue until docking device 310 is powered down and/or removed from the coverage area of network 100. In this case the process moves to 312 where network AP configuration manager 222 of server 115 detects an access point change trigger and determines that docking device 106 is no longer available to provide access point service. AP configuration manager 222 may update heat map database 228 to remove docking device 106 from the access point service in network 100.

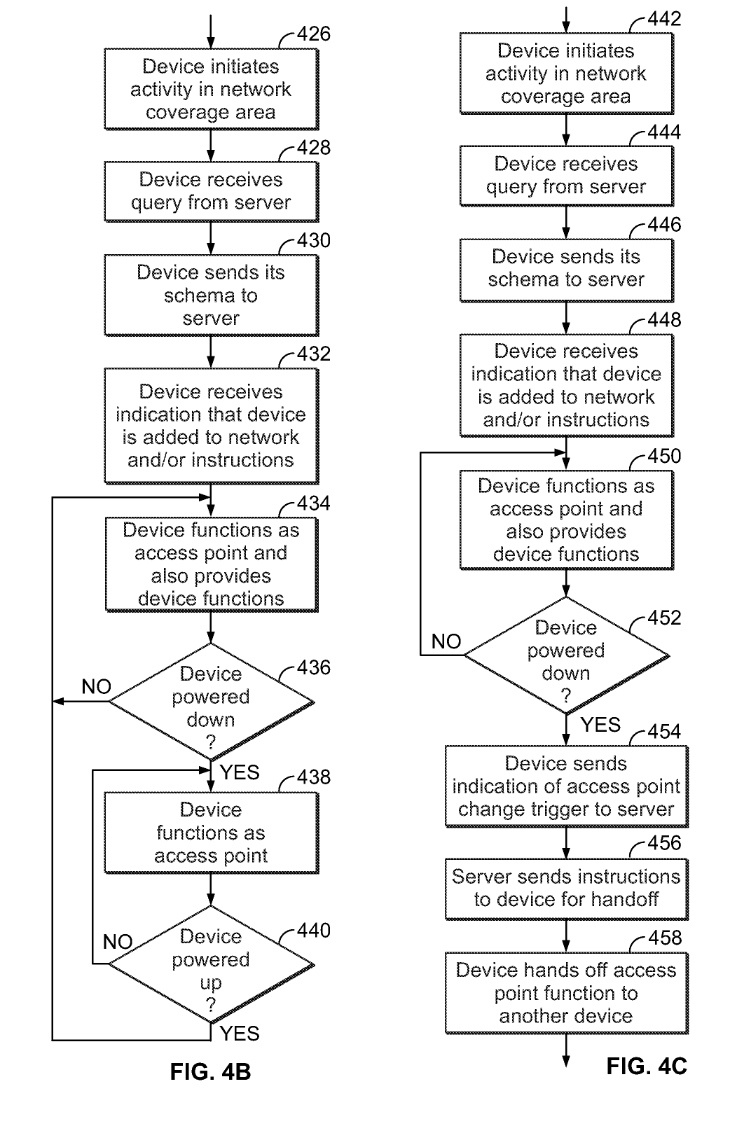

FIG. 4A is a flow diagram of operations performed by an example apparatus managing dynamic access point functions for a network. FIG. 4A illustrates an apparatus functioning according to the implementation of FIG. 3 in which a device schema is provided to the apparatus by a multi-function device. In FIG. 4A, the device schema is used to facilitate management of the multi-function device as an access point, FIG. 4A may be explained at the apparatus/device level with reference to FIGS. 1A-1D and FIG. 3, and using docking device 106 and server 115 as the device and server, respectively, of FIG. 4A.

The process begins at 402 where server 115 determines that initial activity of docking device 106 has occurred in network 100. The initial activity of docking device 106 may be the powering up of docking device 106 with the intention of using docking device 106 to perform the function of connecting storage device 110 and headset device 112 to display monitor device 104. In an implementation, server 115 may receive a registration/alert message from docking device 106 that docking device 106 has been powered up in the coverage area of network 100. At 404, in response to receiving the registration message sent from docking device 106, server 115 may send a query to docking device 106 requesting a device schema. The initial activity of docking device 106 may also include docking device 106 being moved into the coverage area of network 100 while already being powered on. Additionally, the initial activity by docking device 106 may comprise an initial access to network 100 at a network access point (access point 108 or 122), or another multi-function device providing access point services, to connect to network 100 and obtain access point services. The infrastructure service of network 100 may be configured to detect these or other types of initial activity by docking device 106.

At 406, server 115 may receive the schema from docking device 106. As described in relation to 304 of FIG. 3, the schema for docking device 106 may comprise information including a “name”, “type”, “location”, “location accuracy”, and “type of service”. The device name may uniquely identify docking device 106 among other devices in network 100. The device type may be designated as stationary send-fixed since docking device 106 may not normally be moved when being used. Docking device 106 may be assigned a location accuracy of 80% based on the device being stationary semi-fixed and not likely to be moved when in use. Also, docking device 106 may be assigned a type of service including one or more parameters that indicate its technical capabilities to provide internet service. Because docking device 106 communicates with, and is managed by, server 115, the type of service may include an indication that docking device 106 is managed by the IT that is responsible for network 100. The indication that docking device 106 is managed by IT also may inform server 115 as to which access service programs/code including which APIs, docking device, has installed.

At 408, server 115 determines if docking device 106 is able to provide services as an access point that are needed by network 100. For example, server 115 may determine if docking device 106 may provide internet access for streaming media over a fast connection at a desired power level while being managed by server 115. If server 115 determines that docking device is not able to provide the desire services according to various criteria, the process moves to 410, server 115 does not add docking device 106 to network 100 as an access point, and the process ends. If server 115 determines that docking device 106 is able to provide the desired services according to the various criteria the process moves to 409.

At 409, server 115 configures access point service though docking device 106. The configuration of access point service may include the sending of operating instructions by server 115 to docking device 106 that instruct docking device 106 on what operating parameters to use. The communications between docking device 106 and server 115 may implemented here using APIs to send and receive action frames including information elements, as was described in relation to operation 304 of FIG. 3. The operating parameters may define parameters such as data rates, channel sets, security procedures, and verification procedures to be used by docking device 106 when functioning as an access point. In an alternate implementation, the configuration at 409 may include instructing clocking device 106 to implement operating parameters according to programs/code that may be pre-stored in docking device 106. Next, at 414, server 115 updates the network heat map to account for the availability of docking device 106 to provide access point service.

At 416, server 115 manages docking device 106 and other network access points (or multi-function devices) providing access point service in network 100. Server 115 performs this management based on the network heat map and on the occurrence of access point change triggers and service change triggers in the network as was described in relation to operation 310 of FIG. 3. While performing the operations of 416, server 115 may periodically determine, at 418, if docking device 106 has been powered down or removed from network 100. A determination of the powering down or the removal of docking device 106 would comprise an access point change trigger of operation 310. If it is determined that docking device has not been removed from network 108, the process returns to 416 where server 115 continues to manage docking device 106 and the other network access points. If it is determined that docking device has been removed from network 100, the process moves to 420 where server 115 updates the network heat map to reflect the removal of docking device 106 as an access point. The process then moves to 422 where server 115 manages the other access points of network 100.

FIG. 4B is a flow diagram of example operations performed by an implementation of a device operable to provide both a device function and dynamic access point service. FIG. 4B illustrates a multi-function device functioning according to an implementation of FIG. 3 in which the device is configured to send a device schema to a server that manages network access point service according to the process of FIG. 4A. In the implementation of FIG. 4B, once the multi-function device is added to the network as a provider of access point service, the multi-function device is available to provide access point service regardless of whether or not a user powers down the functions of the device other than the access point function. FIG. 4B may be explained with reference to FIG. 4A using docking device 106 and server 115, respectively, as the device and server.

The process begins at 426 where docking device 106 begins initial activity in the coverage area of network 100. The initial activity of docking device 106 may be the powering up of docking device 106 with the intention of using docking device 106 to perform the function of connecting storage device 110 and headset device 112 to display monitor device 104 as shown in FIG. 1A. In an implementation, docking device 106 may send a registration/alert message to server 115 through AP 108 indicating that docking device 106 has been powered up in the coverage area of network 100. The initial activity of docking device 106 may also include docking device 106 being moved into the coverage area of network 100 while already being powered on. Additionally, the initial activity by docking device 106 may comprise an initial access to network 100 at a network access point (access point 108 or 122), or another multi-function device providing access point services, to connect to network 100 and obtain access point services. The infrastructure service of network 100 may be configured to detect these or other types of initial activity by docking device 106.

At 428, docking device 106 receives a query from server 115 through AP 108 requesting a device schema for docking device 106. Server 115 may send the query to docking device 106 in response to receiving the registration/alert message form docking device 106. At 430, docking device 106 sends the device schema of docking device 106 to server 115 through AP 108. The schema of docking device 106 sent at 430 may be as is described in relation to operation 406 of FIG. 4A.

At 432, docking device 106 receives an indication from server 115 through AP 108 that docking device 106 is added to network 100 as an access point service provider. Docking device 106 may also receive instructions from server 115 that instruct docking device 106 on what operating parameters to use for access point service. The communications between docking device 106 and server 155 at 432 may be performed as was described for operation 310 of FIG. 3 and operation 409 of FIG. 4A.

For example, the operating parameters may define parameters such as data rates, channels, security procedures, and verification procedures to be used by docking device 106 when functioning as an access point. The instructions received at 432 also include AP function control programs/code that is to be used in operation as an access point. In the implementation of FIG. 4B, the AP function control programs/code may include override code that overrides the power off functions of docking device 106 that are controlled by a user of the device. This override code to allow server 115 to independently have control of the powering on/powering off of the network access point service provided by docking device 106. In an alternate implementation, the indication received by docking device 106 at 432 may instruct docking device 106 to implement operating parameters according to AP function control programs/code that may be pre-stored in docking device 106 when operating as an access point.

At 434, docking device 106 begins functioning to provide access point services for network 100 while also providing the device function of a docking device. For example, at 434, the state of docking device 106 may initially be as shown in FIG. 1B, with docking device 106 providing docking functions to connect storage device 110, headset device 112, printer device 120, and display monitor 104 with one another, and providing access point functions to connect devices 114 to network 100 to network access point 108 and network 100.

At 434, docking device 106 continues to provide access point services and docking device service until docking device 106 is powered down at 436. The powering down may be, for example, a manual powering down initiated by a user with the intention of shutting down the docking function provided by docking device 106, or a powering down in response to a time out when no docking activity by docking device 106 is detected after a certain time period. Upon power down of docking device 106 the process moves to 438. At 438, the AP function control programs/code function to keep the power on for the access point functions in docking device 106, and docking device 106 continues to provide access point functions for network 100 even though the docking functions have been powered down/disabled. Because the powering down at 436 only affects the docking function, server 115 does not detect an access point change trigger.

At 438, the state of docking device 106 may be as shown in FIG. 1D, with docking device 106 no longer providing docking connection functions to connect storage device 110, headset device 112, printer device 120, and display monitor 104 with one another, but with docking device still providing access point functions to connect computing device 114 to network access point 108 and network 100 through connections 132 and 124.

Docking device 106 continues to provide access point services without providing docking device functions until docking device 106 is powered up at 440. The powering up at 440 may be a manual powering up initiated by a user with the intention of using the docking function provided by docking device 106. When docking device 106 is powered up at 440, the power is reinstated for the docking functions of docking device 106, Upon the powering up, the process returns to 434. At 434, docking device 106 functions to provide access point service for network 100 while also providing the device function of a docking device.

The process will continue to repeat operations 434, 436, 438, and 440 as the docking functions of docking device 106 are switched on or off in accordance with the powering up or powering down of docking device 106. The AP function control programs/code will keep the access point functions of docking device 106 active and functioning throughout these operations. The process may continue until docking device 106 is removed from network 100 or the access point and or docking functions of docking device 106 are otherwise disabled.

FIG. 4C is a flow diagram of example operations performed by another implementation of a device operable to provide both a device function and access point service. FIG. 4C illustrates a multi-function device functioning according to an implementation of FIG. 3 in which the device is also configured to only provide access point functions for a network dependent on the device being powered on for the purpose of providing one of more other device functions. For example, once the multi-function device is added to the network as an access point, the multi-function device provides access point services dependent on whether the multi-function device is turned on for providing device functions other than the access point service. FIG. 4C may be explained with reference to FIG. 4A using docking device 106 and server 115, respectively, as the device and server.

In the process of FIG. 4C, operations 442, 444, 446, 448, 450, and 452 may performed in a similar manner as was described for operations 426, 428, 430, 432, 434, and 436, respectively, of FIG. 4B until it is determined that docking device 106 is powered down at 452. Upon power down of docking device 106 the process moves to 454.

At 454, docking device 106 sends an access point change trigger to server 115. The access point change trigger comprises an indication that docking device 106 is being powered down. At 456, server 115 sends instructions to docking device 106 on how to handoff its current access point service traffic to one or more other access points or multi-function devices that provide access point service. At 458, docking device hands off its current access point service traffic to another access point. The state of docking device 106 may then be as shown in FIG. 1C, with docking device 106 no longer providing docking connection functions and no longer providing access point service for network 100. The process then ends. The process of FIG. 4C may begin again if docking device 106 initiates new activity in the coverage area of network 100.

At 458, the state of docking device 106 may be as shown in FIG. 1C, with docking device 106 no longer providing docking connection functions to connect storage device 110, headset device 112, printer device 120, and display monitor 104 with one another, and with docking device no longer providing access point functions to connect computing device 114 to network access point 108 computing device 114 has been handed off to printer device 120 which now provides access point services to computing device 114.

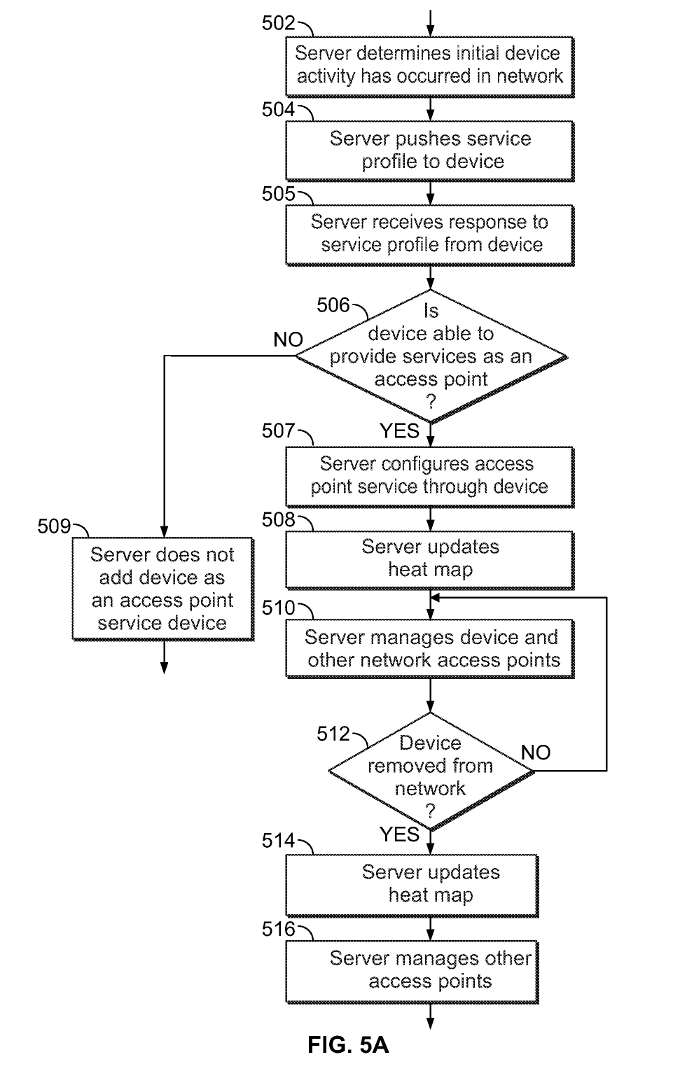

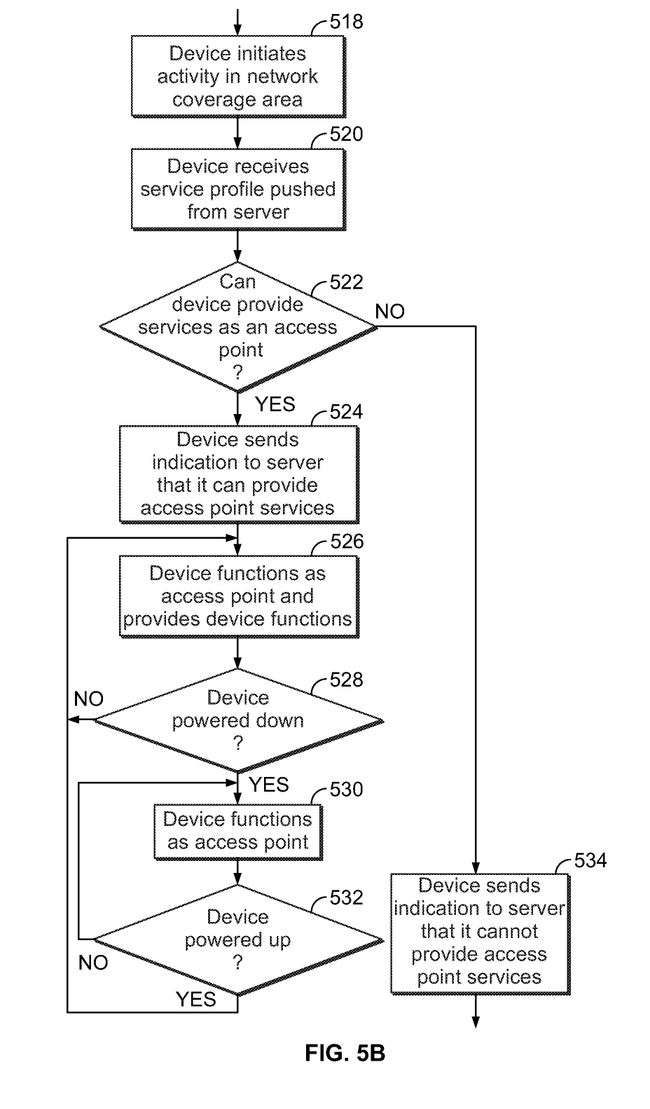

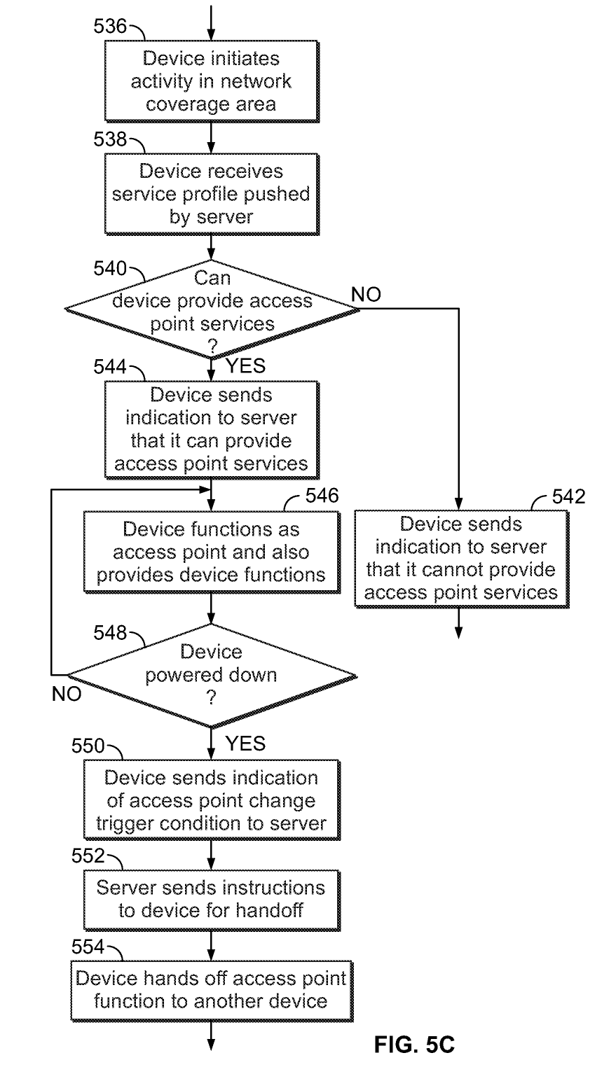

FIG. 5A is a flow diagram of operations performed by another example apparatus managing dynamic access point functions for a network. FIG. 5A illustrates an apparatus functioning according to the implementation of FIG. 3 in which the apparatus pushes a service profile for access point services to a multi-function device. In FIG. 5A, the service profile is used to facilitate management of the multi-function device as an access point. FIG. 5A may be explained at the apparatus/device level with reference to FIGS. 1A-1D and FIG. 3, and using docking device 106 and server 115 as the device and server, respectively, of FIG. 5A.

The process begins at 502 where server 115 determines that initial activity of docking device 106 has occurred in network 100. The initial activity of docking device 106 may be the powering up of docking device 106 with the intention of using docking device 106 to perform the function of connecting storage device 110 and headset device 112 to display monitor device 104. In an implementation, server 115 may receive a registration/alert message from docking device 106 indicating that docking device 106 has been powered up in the coverage area of network 100. The initial activity of docking device 106 may also include docking device 106 being moved into the coverage area of network 100 while already being powered on. Additionally, the initial activity by docking device 106 may comprise an initial access to network 100 at a network access point (access point 108 or 122), or another multi-function device providing access point services, to connect to network 100 and obtain access point services. The infrastructure service of network 100 may be configured to detect these or other types of initial activity by docking device 106.

At 504, in response to determining that the initial activity has occurred, docking device 106, server 115 may push a service profile to docking device 106. The service profile may set out network requirements for a device providing access point service in network 100. In an implementation, the service profile pushed to docking device 106 may include relevant information similar to the information in the device schema described in relation to operation 310 of FIG. 3. For example, the profile may include a type, location, location accuracy, and a type of service. The device type, location accuracy, and a type of service may be provided as a set of one or more acceptable values, or as a range of acceptable values. In one example, the service profile may include one or more device type, such as stationary fixed, stationary semi-fixed, or mobile. If docking device 106 is of a device type included in the service profile, docking device 106 is acceptable by network 100, as far as device type, for providing access point service. For example, if server 115 is not capable of managing mobile devices the service profile may include stationary fixed and stationary semi-fixed device types, but not the mobile device type. In another example, the location accuracy may include a value, such as 80%, indicating minimum location accuracy that is acceptable for docking device 106. If docking device 106 has a location accuracy of greater than 80%, docking device 106 is acceptable by network 100, as far as location accuracy, for providing access point service. In a further example, the service profile may indicate one or more types of service, such as internet service, fast or slow connection service, managed service, or guest access service, needed by network 100. If docking device 106 is capable of providing one of the one or more types of service in the service profile, docking device 106 is acceptable by network 100, as far as type of service, for providing access point service. The service profile sent to docking device 106 by server 115 may also include network requirements related to performance parameters that docking device 106 may be required to provide. This may include performance parameters such as available transmission power levels and supported data rates needed by network 100 for access point services. If docking device 106 is able to meet these performance parameters, docking device 106 is acceptable by network 100, as far as performance, for providing access point service.

At 506, server 115 receives a response from docking device 106 that indicates whether docking device 106 meets the service profile requirements of the service profile. If docking device 106 is not able to provide access point services in accordance with the service profile, the process moves to 509 and server 115 does not add docking device 106 to network 100 as a device that may provide access point service. If docking device 106 is able to provide access point services in accordance with the service profile, the process moves to 507.

At 507, server 115 configures access point service though docking device 106. The operations at 507, 508, 510, 512, 514, and 516 of FIG. 5A may then be performed in a similar manner as are operations 409, 414, 416, 418, 420, and 422 of FIG. 4A.

FIG. 5B is a flow diagram of example operations perforated by an implementation of a device operable to provide both a device function and access point service. FIG. 5B illustrates a multi-function device operating according to an implementation of FIG. 3 in which the device is configured to receive a service profile from a server that manages network access point service according to the process of FIG. 5A. In the implementation of FIG. 5B, once the multi-function device is added to the network as a provider of access point service, the multi-function device is available to provide access point service regardless of whether or not a user powers down the functions of the device other than the access point function. FIG. 5B may be explained with reference to FIG. 5A using docking device 106 and server 115, respectively, as the device and server.

The process begins at 518 where docking device 106 begins initial activity in the coverage area of network 100. The initial activity of docking device 106 may be the powering up of docking device 106 with the intention of using docking device 106 to perform the function of connecting storage device 110 and headset device 112 to display monitor device 104 as shown in FIG. 1A. In an implementation, docking device 106 may send a registration/alert message to server 115 through AP 108 indicating that docking device 106 has been powered up in the coverage area of network 100. The initial activity of docking device 106 may also include docking device 106 being moved into the coverage area of network 100 while already being powered on. Additionally, the initial activity by docking device 106 may comprise an initial access to network 100 at a network access point (access point 108 or 122), or another multi-function device providing access point services, to connect to network 100 and obtain access point services. The infrastructure service of network 100 may be configured to detect these or other types of initial activity by docking device 106.

At 520, docking device 106 receives a service profile that is pushed from server 115. Server 115 may send the service profile to docking device 106 in response to detecting the initial activity of docking device 106. In an implementation, the service profile may be similar to the service profile described in relation to operation 504 of FIG. 5.

At 522, based on the service profile, docking device 106 determines whether or not it can provide services as an access point in accordance with the service profile. If docking device 106 is not able to provide access point service in accordance with the service profile, the process moves to 534, docking device sends an indication to server 115 that it cannot provide access point services, and the process ends. If docking device 106 is able to provide access point service in accordance with the service profile, the process moves to 524 and docking device 106 sends an indication to server 115 that it can provide access point services in accordance with the service profile. From 524 the process moves to 526.

The operations at 526, 528, 530, and 532 of FIG. 5B may then be performed in a similar manner as are operations 434, 436, 438, and 440 of FIG. 4B.

FIG. 5C is a flow diagram of example operations performed by another implementation of a device operable to provide both a device function and access point service. FIG. 5C illustrates a multi-function device operating, according to an implementation of FIG. 3 in which the device is configured to only provide access point functions for a network dependent on the device being powered on for the purpose of providing one of more other device functions. In the process of FIG. 5C, once the multi-function device is added to the network as an access point, the multi-function device provides access point services dependent on whether the multi-function device is turned on for providing device functions other than the access point service. FIG. 5C may be explained with reference to FIG. 3A using docking device 106 and server 115, respectively, as the device and server.

In the process of FIG. 5C, operations 536, 538, 540, 544, 546, 548, and 542 may performed in a similar manner as was described for operations 518, 520, 522, 524, 526, 528, and 534, respectively, of FIG. 5B. If the process reaches operation 548 and it is determined that docking device 106 is powered down, the process moves to 550.

At 550, the docking device 106 sends an access point change trigger to server 115. The access point change trigger comprises an indication that docking device 106 is being powered down. At 552, server 115 sends instructions to docking device 106 on how to handoff its current access point service traffic to one or more other access points or multi-function devices that provide access point service. At 554, docking device hands off its current access point service traffic to another access point. The state of docking device 106 may then be as shown in FIG. 1C, with docking device 106 no longer providing docking connection functions and no longer providing access point service for network 100. The process then ends. The process of FIG. 5C may begin again if docking device 106 initiates new activity in the coverage area of network 100.

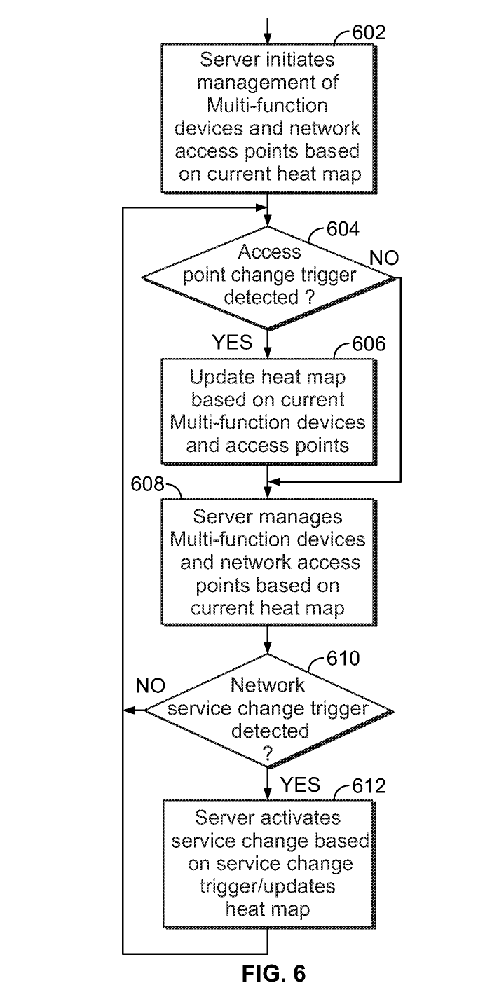

FIG. 6A is a flow diagram of further operations performed by an example apparatus managing access point service for a network. For example, the process of FIG. 6 may be performed by an apparatus when performing operation 310 of FIG. 3, operation 416 of FIG. 4A, or operation 510 of FIG. 5A. FIG. 6A may be explained at the apparatus/device level with reference to FIGS. 1A-1D and FIG. 3, using docking device 106 and printer device 120 as the devices, and server 115 as the server referred to in FIG. 6A.

The process begins at 602 where server 115 initiates, management of the multi-function devices and network access points based on the current beat map. Operation 602 may be entered upon completion of latest update of the heat map with current device schemas and current access point service conditions, During management of the multi-function devices and network access points at 602, server 115 may monitor for access point change triggers and network service change triggers.

At 604, server 115 determines if an access point change trigger has been detected. An access point change trigger may include events as described in relation to operation 310 of FIG. 3 that remove or add a multi-function device or an access point to the access point service infrastructure of network 100. For example, an access point change trigger may include the detection of the powering down of an access point, or the powering down of a multi-function device that removes the powered down access point or device from providing access point service. For example, an access point change trigger may include the detection of a powering down of docking device 106 or printer device 120. An access point change trigger may also include the detection of the powering up of a new multi-function device capable of providing both a device function and access point service, or installation of a permanent access point. If, at 604, server 115 determines that no access point change trigger has occurred, the process moves to 608. At 608, server 115 continues to manage the multi-function devices based on the current heat map (as was used in 602).

If, at 604, server 115 determines that an access point change trigger has occurred, the process moves to 606. At 606, server 115 updates the heat map based on the current multi-function devices and access points that are available to provide access point service after the access point change trigger occurs. The process next moves to 608.

At 608, server 115 continues to manage the multi-function devices based on the current heat map (as updated at 606). During management of the multi-function devices and network access points at 608, server 115 may monitor for access point change triggers and network service change triggers.

At 610, server 115 determines if a network service change trigger has been detected. A network service change trigger may include events as described in relation to operation 310 of FIG. 3 that affect access point service in network 100. For example, a service change trigger may include the detection of traffic congestion or the detection of a lowered quality of service on one or more access point service channels. If, at 610, server 115 determines that no service change trigger has occurred, the process moves back to 604. At 604, server 115 continues to manage the multi-function devices based on the current heat map as last updated. If, at 610, server 115 determines that a service change trigger has occurred, the process moves to 612.

At 612, server 115 activates a service change based on the service change trigger. At 612, server 115 may also update the heat map to account for the service change. The service change at 612 may include performing operations as described for operation 310 of FIG. 3. For example, a service change may include instructing docking device 106 or printer device 120 to handover, or receive handover of, data traffic to/from other access points or multi-function devices in network 100 that become congested with access service traffic. The management may also include changing operating parameters of the access point function of docking device 106 or printer device 120. For example data transmission rates or power transmission levels used by docking device 106 or printer device 120 may be increased, or a channel set used by docking device 106 or printer device 120 may be expanded to account for congestion or slow data rates. In another example, a service change trigger may include the detection that there are adequate access point service resources available and that access point service resources provided by docking device 106 or printer device 120 may be reduced or removed from network 100. For example, the power levels or the size of the channel set used by docking device 106 or printer device 120 may be reduced if those resources are not currently needed. From 612, the process moves back to 604 where server 115 continues to manage the multi-function devices based on the current heat map as last updated.

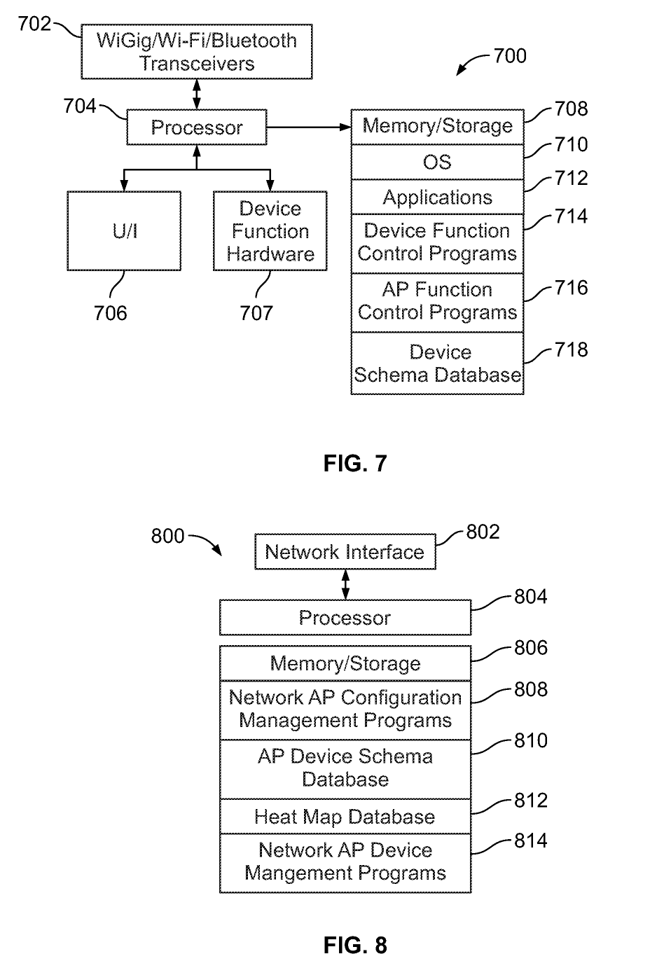

FIG. 7 is a simplified block diagram of an example device 700 operable to provide both a device function and an access point function. Device 700 represents a possible implementation of docking device 106, or printer device 120 of FIGS. 1A-1D that is configured to include the functions shown in FIG. 2A.

Device 700 includes processor 704, WiGig/Wi-Fi/Bluetooth transceivers 702, user interface (U/I) 706, device function hardware 707, and memory/storage 708. Memory/storage 708 includes code and instructions for device function control programs 714, access point (AP) function control programs 716, and device schema database 718. Memory/storage may also include code and instructions for a device operating system (OS) 710, and applications 712.

Processor 704 may comprise one or more processors, or other control circuitry or any combination of processors and control circuitry that provide overall control of device 700 according to the disclosed embodiments. Memory/storage 708 may be implemented as any type of computer readable storage media, including non-volatile and volatile memory.

In the embodiments, access point (AP) function control programs 716 causes processor 704 to provide the functions described for AP function controller 210 of FIG. 2A. In this regard, processor 704 controls WiGig/Wi-Fi/Bluetooth transceivers 702 to provide access point service functions. The access point service functions may be performed as described in relation to the device of FIGS. 4B, 4C, 5B, and 5C.

In an implementation of device 700 as docking device 106, the execution of device function control programs 714 causes processor 704 to control the WiGig/Wi-Fi/Bluetooth transceivers 702 to provide the device functions of a docking device. In an implementation of device 700 as printer device 120, the execution of device function control programs 714 causes processor 704 control device function hardware 707 to provide the device functions of a printer.

FIG. 8 is a simplified block diagram of an example apparatus 800 operable to manage access point functions for a network. Apparatus 800 represents a possible implementation of server 115 of FIGS. 1A-1D that is configured to include the functions shown in FIG. 2B. Apparatus 801 includes processor 804, network interface 802, and memory/storage 806. Memory/storage 806 includes code and instructions for network access point (AP) configuration management programs 808, access point (AP) device schema database 810, heat map database 812, and network access point (AP) device management programs 814.

Processor 804 may comprise one or more processors, or other control circuitry or any combination of processors and control circuitry that provide overall control of apparatus according to the disclosed embodiments. Memory/storage 806 may be implemented as any type of computer readable storage media, including non-volatile and volatile memory.

In the embodiments, AP configuration management programs 808 cause processor 804 to provide the functions described fur network AP configuration manager 222 of FIG. 2B and execution of network access point (AP) device management programs 814 causes processor 804 to provide the access point service functions described for network AP device manager 224 of FIG. 2B. The access point service functions may be provided as described in relation to the device in the processes of FIGS. 4A, 5A, and 6A

The example embodiments disclosed herein may be described in the general context of processor-executable code or instructions stored on memory that may comprise one or more computer readable storage media (e.g., tangible non-transitory computer-readable storage media such as memory 708 or 806). As should be readily understood, the terms “computer-readable storage media” or “non-transitory computer-readable media” include the media for storing of data, code and program instructions, such as memory 708 or 806, and do not include portions of the media for storing transitory propagated or modulated data communication signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is meant to include all such implementations.

The disclosed implementations include an apparatus comprising an interface for communicating with a network, one or more processors coupled to the interface, and, memory in communication with the one or more processors, the memory comprising code that, when executed, causes the one or more processors to control the apparatus to determine that an activity of a device has occurred in the network, wherein the activity is associated with a first function provided by the device, determine that, in addition to providing the first function, the device is able to provide a second function, the second function being provision of access point service for the network, and initiate access point service for the network through the device based on the determination that the device is able to provide the second function. The code may cause the apparatus to initiate access point service by controlling the apparatus to update a network database, and manage the network based at least on the network database. The code may cause the apparatus to manage the network by controlling the apparatus to determine that at least one service change trigger has occurred, and manage the network based at least on the network database and the at least one service change trigger. The code may cause the apparatus to manage the network by controlling the apparatus to determine that at least one access point change trigger has occurred, and manage the network based at least on the network database and the at least one access point change trigger. The activity may comprise power up of the device in the network. The activity may comprise an entry of the device into a coverage area of the network. The code may be executable to cause the one or more processors to control the apparatus to query the device in response to the determination of the activity, receive a schema from the device in response to the query, and determine that the device is able to provide the second function based at least on the schema. The schema may include at least one capability of the device. The code may be executable to further cause the one or more processors to control the apparatus to push a service profile to the device in response to the determination of the activity, receive a response to the service profile from the device, and determine that the device is able to provide the second function based at least on the response.

The disclosed implementations also include a device comprising a transceiver, one or more processors in communication with the transceiver, and memory in communication with the one or more processors, the memory comprising code that, when executed, causes the one or more processors to control the device to initiate activity within a network coverage area, wherein the activity is associated with a first function provided by the device, communicate with an apparatus, the communication relating to the capability of the device to provide a second function, the second function being provision of access point service for the network through the transceivers, and, operate to provide at least one of the first function and the second function while in the coverage area of the network. The code may cause the device to communicate with the apparatus by controlling the device to send a schema including at least one access point characteristic of the device to the apparatus. The code may cause the device to communicate with the apparatus by controlling the device to receive an access point service profile from the apparatus. The code may further control the device to receive an instruction from the apparatus, and, in response to the receiving of the instruction, operate to provide only the second function while in the coverage area of the network. The code may further control the device to determine that an access point change trigger has occurred, and, in response to the determination, send an indication of the trigger occurrence to the apparatus. The device may comprise a first device that is providing access point service to a second device, and the code may further control the first device to receive instructions to handoff the second device to a third device that provides access point service, and, in response to receiving the instructions, handoff the second device to the third device. The code may be further executable to cause the one or more processors to control the apparatus to control the transmission power of the device or the transmission power of at least one access point in providing the access point service for the network based on one or more triggers. The one or more triggers may include an access point change trigger. The one or more triggers may include a service change trigger

The disclosed implementations further include an apparatus comprising a server configured to manage a plurality of access points to provide network access services, wherein the server manages the plurality of access points to provide the network access services based on a network database including information on each of the plurality of access points, and wherein the network database is updated by adding a multi-function device as one of the plurality of access points based at least on an occurrence of a trigger event in the coverage area of the network. The trigger event may comprise a change in a system parameter. The trigger event may be related to an activity associated with the multi-function device in the coverage area of the network. The trigger event may comprise a first trigger event and the network database is further updated by removing the multi-function device as one of the plurality of access points based at least on an occurrence of a second trigger event in the coverage area of the network. The second trigger event may comprise the cessation of the activity of the selected multi-function device in the coverage area of the network. The server may further manage the plurality of access points by adjusting the transmission power of a selected one of the plurality of access points based on the occurrence of a second trigger event.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus comprising:
one or more processors; and,
memory in communication with the one or more processors, the memory comprising code that, when executed, causes the one or more processors to control the apparatus to:
determine that an activity of a device has occurred in the network, wherein the activity is associated with a first function provided by the device;
determine that, in addition to providing the first function, the device is able to provide a second function, the second function being provision of access point service for the network; and,
initiate access point service for the network through the device based on the determination that the device is able to provide the second function.

2. The apparatus of claim 1, wherein the code causes the apparatus to initiate access point service by controlling the apparatus to:
update a network database; and,
manage the network based at least on the network database.

3. The apparatus of claim 2, wherein the code causes the apparatus to manage the network by controlling the apparatus to:
determine that at least one service change trigger has occurred; and,
adjust one or more operating parameters of the device based at least on the network database and the at least one service change trigger.

4. The apparatus of claim 2, wherein the code causes the apparatus to manage the network by controlling the apparatus to:
determine that at least one access point change trigger has occurred; and,
adjust one or more operating parameters of the device based at least on the network database and the at least one access point change trigger.

5. The apparatus of claim 1, wherein the activity comprises power up of the device in the network.

6. The apparatus of claim 1, wherein the activity comprises an entry of the device into a coverage area of the network.

7. The apparatus of claim 1, wherein the code is executable to further cause the one or more processors to control the apparatus to:
query the device in response to the determination of the activity;
receive a schema from the device in response to the query; and
determine that the device is able to provide the second function based at least on the schema.

8. The apparatus of claim 7, wherein the schema includes at least one capability of the device.

9. The apparatus of claim 1, wherein the code is executable to further cause the one or more processors to control the apparatus to:
push a service profile to the device in response to the determination of the activity;
receive a response to the service profile from the device; and,
determine that the device is able to provide the second function based at least on the response.

10. The apparatus of claim 1, wherein the code is executable to further cause the one or more processors to control the apparatus to adjust the transmission powers of devices providing access point service for the network based on one or more triggers.

11. A device comprising:
a transceiver;
one or more processors in communication with the transceiver; and,
memory in communication with the one or more processors, the memory comprising code that, when executed, causes the one or more processors to control the device to:
initiate activity within a network coverage area, wherein the activity is associated with a first function provided by the device;
communicate with an apparatus, the communication relating to the capability of the device to provide a second function, the second function being provision of access point service for the network through the transceiver; and,
operate to provide at least one of the first function and the second function while in the coverage area of the network.

12. The device of claim 11, wherein the code causes the device to communicate with the apparatus by controlling the device to send a schema including at least one access point characteristic of the device to the apparatus.

13. The device of claim 11, wherein the code causes the device to communicate with the apparatus by controlling the device to receive an access point service profile from the apparatus.

14. The device of claim 11, wherein the code further controls the device to:
receive an instruction from the apparatus; and,
in response to the receiving of the instruction, operate to provide only the second function while in the coverage area of the network.

15. The device of claim 11, wherein the code further controls the device to:
determine that an access point change trigger has occurred; and,
in response to the determination, send an indication of the trigger occurrence to the apparatus.

16. The device of claim 15, wherein the device comprises a first device that is providing access point service to a second device, and the code further controls the first device to:
receive instructions to handoff the second device to a third device that provides access point service; and,
in response to receiving the instructions, handoff the second device to the third device.

17. An apparatus comprising:
a server configured to manage a plurality of access points to provide network access services, wherein the server manages the plurality of access points to provide the network access services based on a network database including information on each of the plurality of access points, and wherein the network database is updated by adding a multi-function device as one of the plurality of access points based at least on an occurrence of a trigger event in the coverage area of the network.

18. The system of claim 17, wherein the trigger event comprises a change in a system parameter.

19. The system of claim 17, wherein the trigger event is related to an activity associated with the multi-function device in the coverage area of the network.

20. The system of claim 19, wherein the trigger event comprises a first trigger event and the network database is further updated by removing the multi-function device as one of the plurality of access points based at least on an occurrence of a second trigger event in the coverage area of the network.

21. The system of claim 20, wherein the second trigger event comprises the cessation of the activity of the multi-function device in the coverage area of the network.

22. The system of claim 17, wherein the trigger comprises a first trigger event and the server further manages the plurality of access points by adjusting the transmission power of a selected one of the plurality of access points based on the occurrence of a second trigger event.
